(19) United States
(12) Patent Application Publication
(10) Pub. No.: US 2026/0127983 A1
(43) Pub. Date: May 7, 2026

(54) DENTAL FASTENER AND DENTAL MODEL WITH INTEGRATED FIXTURE

(71) Applicants: Russell J. Crockett, Casa Grande, AZ (US); Chung Hua Danny Yao, Fountain Valley, CA (US)

(72) Inventors: Russell J. Crockett, Casa Grande, AZ (US); Chung Hua Danny Yao, Fountain Valley, CA (US)

(21) Appl. No.: 18/935,052

(22) Filed: Nov. 1, 2024

(51) Int. Cl. G09B 23/34; B33Y 80/00

(52) U.S. Cl. CPC G09B 23/34; B33Y 80/00

(57) ABSTRACT

A dental fastener for fastening a prosthesis to a physical model is described. The dental fastener has a screw with an external thread and a head. The dental fastener also includes a library file for making a digital model of a dental arch with interfacing surfaces that mate with a prosthesis and an internal thread that mates with the external thread of the screw. The library file includes a three-dimensional digital image of one or more interfacing surfaces of a fixture or implant, and a three-dimensional digital image of an internal thread configured to couple with the external thread of the screw. The three-dimensional digital images are positioned with a scanned image of the dental arch and melded to the scanned image to form a digital model.

### FIELD OF THE INVENTION

The field of the invention is dental fasteners and dental models, more specifically, screws for attaching a prosthesis to a physical model of a dental arch made of a soft material, and related library files for creating a dental model with an integrated fixture.

### BACKGROUND

The following description includes information that may be useful in understanding the present invention. It is not an admission that any of the information provided herein is prior art or relevant to the presently claimed invention, or that any publication specifically or implicitly referenced is prior art.

Dental models of dental arches are used to verify the fitment and placement of prosthetics. Current techniques for fastening prosthetics to models first requires placing and attaching a metal dental analog in a stone model at the location where the prosthetic is to be installed. However, this approach is time consuming and does not leverage modern manufacturing techniques and materials. It would be advantageous to provide a dental model with an integrated dental analog or fixture. It would also be advantageous to provide a dental fastener that can couple with a dental model made of a softer material, such as resin.

Thus, there still remains a need in the art for improved dental fasteners, dental models, and their methods of manufacture and use.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which a dental fastener can fasten a prosthesis to a physical model of a dental arch. In some embodiments, the physical model is made of a soft and flexible material, such as resin, and the dental fastener is made of a hard and brittle material, such as metal or ceramic. The dental fastener comprises a screw having an external thread and a head. The external thread of the screw is configured to fasten with an internal thread of the physical model, and the head of the screw is sized and dimensioned to fit inside a hole or opening of the prosthesis. The head of the screw can also have a negative space (e.g., hole or opening) that is sized and dimensioned to mate with a tool (e.g., screw driver).

The dental fastener also includes a library file for generating a digital model of a dental arch that has an integrated fixture or analog. More specifically, the library file can be used to design a digital model of a dental arch that has (i) interfacing surfaces of an implant that are configured to mate with the prosthesis, and optionally, (ii) an internal thread configured to mate with the screw. The digital model can then be used to manufacture a physical model with the interfacing surfaces and internal thread integrated in the physical model using modern manufacturing techniques and materials, such as 3D printing and resin. The library file comprises a three-dimensional digital image of one or more interfacing surfaces of a fixture or implant, and a three-dimensional digital image of an internal thread configured to couple with the external thread of the screw. The digital model is generated by accurately positioning these three-dimensional digital images with a scanned image of a dental arch, and melding the three-dimensional digital images to the scanned image.

The dental arch in the scanned image has a fixture or implant installed therein, with a scan body attached to the fixture or implant. The three-dimensional image of the interfacing surfaces in the library file are sized and dimensioned to represent the interfacing surfaces of the fixture or implant in the dental arch. The library file also can include a three-dimensional image of the scan body, with a defined position relative to the three-dimensional image of the interfacing surfaces and the internal thread. The defined positions can be used to accurately position the three-dimensional image of the interfacing surfaces and the internal thread to the scanned image of the dental arch to create the digital model with an integrated fixture.

The library file can optionally include a three-dimensional digital image of one or more interfacing surfaces of the prosthesis. In some instances, the interfacing surfaces of the prosthesis is a bottom surface of an abutment. The abutment can be an integral and unitary part of the prosthesis. In other embodiments, the abutment is a separate component that is attached to a crown to form the prosthesis. It is contemplated that the library file can include a three-dimensional image of the entire prosthesis, not just the interfacing surfaces, so that the prosthesis can be placed on the digital model of the dental arch for visualizing fitment and tolerances in a digital environment prior to manufacturing the physical model.

The external thread of the screw and the internal thread of the digital model are preferably identical or at least sufficiently similar to rotatably mate with one another. In some embodiments, the external thread of the screw and the internal thread of the digital model are different than an internal thread in the fixture or implant that is placed in the dental arch of the scanned image. Since the fixture or implant is made of a hard material such as metal, and is designed to be permanently placed in a person's mouth, it has internal threads that are not well suited for use in a resin model. When the physical model of the dental arch is made of a soft material, such as resin, the internal thread of the model can be different than the internal thread of the permanent fixture or implant. For example, the internal thread of the model, as well as the external thread of the screw, can have a thread-pitch-to-thread-diameter ratio of at least 0.25, more preferably at least 0.26, and a thread depth (thread-minor-diameter-to-thread-major-diameter) ratio of no more than 0.7, more preferably no more than 0.68. One of ordinary skill in the art will appreciate that these thread dimensions are too large for the metal screws and the metal fixtures/implants that are permanently placed inside the dental arch of a person or patient. However, these dimensions are advantageous for attaching a metal or ceramic screw to the internal threads of a physical model made of a soft material, such as resin.

The inventive subject matter provides apparatus, systems, and methods in which a library file is provided for generating a digital model of a dental arch. The library file includes a three-dimensional image of one or more interfacing surfaces of a fixture or implant, and a three-dimensional image of an internal thread, wherein the internal thread has a thread-pitch-to-thread-diameter ratio of at least 0.25, and a thread depth ratio of no more than 0.7.

The inventive subject matter also includes a method of designing a three-dimensional digital model of a dental arch having (i) one or more interfacing surfaces for coupling with one or more interfacing surfaces of a prosthesis and optionally, (ii) an internal thread configured to couple with an external thread of a dental fastener. The method includes the step of positioning, in a digital environmental, (i) a three-dimensional image of one or more interfacing surfaces of the fixture or implant and (ii) a three-dimensional image of an internal thread, with (iii) a scanned image of the dental arch. The method also includes the step of removing, in the digital environment, a scan body from the scanned image of the dental arch. The method further includes the step of melding, in the digital environment, (i) the three-dimensional image of the one or more interfacing surfaces of the fixture or implant and (ii) the three-dimensional image of the internal thread, into (iii) the scanned image of the dental arch.

The inventive subject matter also includes a self-tapping dental fastener for fastening a prosthesis to a physical model. The self-tapping dental fastener comprises a self-tapping screw having an external thread and a head, and a library file for generating a digital model of a dental arch. The library file has (i) a three-dimensional digital image of one or more interfacing surfaces of the prosthesis, and (ii) a three-dimensional digital image of one or more interfacing surfaces of a fixture or implant. In some embodiments, the library file can further include a three-dimensional digital image of a through-hole having an inner diameter that is smaller than an outer diameter of the external thread of the self-tapping screw, wherein the self-tapping screw is configured to cut into the inner diameter. However, in other embodiments, it is also contemplated that the library file could have a three-dimensional digital image of a blind-hole with a bottom surface, wherein the self-tapping screw is configured to penetrate and cut into the bottom surface. The bottom surface of the blind-hole could also have a divot, detent, or tiny hole to help the self-tapping screw to start cutting and penetrating.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A shows a front view of a prosthesis.

FIG. 1B shows a cross-sectional view of the prosthesis of FIG. 1A.

FIG. 1C shows a front, bottom, side perspective view of the prosthesis of FIG. 1A.

FIG. 2A shows a front view of a dental fastener.

FIG. 2B shows a cross-sectional view of the dental fastener of FIG. 2A.

FIG. 2C shows a front, top, perspective view of the dental fastener of FIG. 2A.

FIG. 3A shows a front, top, perspective view of a three-dimensional digital image of an object that has (i) interfacing surfaces configured to couple with the prosthesis of FIG. 1A, and (ii) an internal thread configured to couple with the dental fastener of FIG. 2A.

FIG. 3B shows a front, bottom, perspective view of the three-dimensional digital image of FIG. 3A.

FIG. 3C shows a front view of the three-dimensional digital image of FIG. 3A.

FIG. 3D shows a cross-sectional view of the three-dimensional digital image of FIG. 3A.

FIG. 4A shows a front view of an analog.

FIG. 4B shows a cross-sectional view of the analog of FIG. 4A.

FIG. 5A shows a front view of a fixture or implant.

FIG. 5B shows a cross-sectional view of the fixture or implant of FIG. 5A.

FIG. 6 shows a scanned image of a dental arch with a scan body attached to a fixture or implant in the dental arch.

FIG. 7A shows a front view of a three-dimensional digital image of a scan body positioned with the three-dimensional digital image of the object of FIG. 3A.

FIG. 7B shows a cross-sectional view of the scan body and object of FIG. 7A.

FIG. 8A shows the scanned image of the dental arch of FIG. 6 positioned with the three-dimensional digital image of FIG. 7A.

FIG. 8B shows a cross-sectional view of the dental arch and three-dimensional digital image of FIG. 8A.

FIG. 9A shows a side view of a digital model of a dental arch having interfacing surfaces and an internal thread.

FIG. 9B shows a side, top, perspective view of the digital model of FIG. 9A.

FIG. 9C shows a side, top, perspective view of the digital model of FIG. 9A in an exploded view with the prosthesis of FIG. 1A and the dental fastener of FIG. 2A.

FIG. 9D shows a side, top, perspective view of the digital model of FIG. 9A coupled with the prosthesis of FIG. 1A and the dental fastener of FIG. 2A.

FIG. 9E shows a side cross-sectional view of the digital model of FIG. 9A coupled with the prosthesis of FIG. 1A and the dental fastener of FIG. 2A.

FIG. 9F shows a side cross-sectional exploded view of the digital model of FIG. 9A, the prosthesis of FIG. 1A, and the dental fastener of FIG. 2A.

FIG. 9G shows a side cross-sectional exploded view of another embodiment of the digital model of FIG. 9A coupled with the prosthesis of FIG. 1A and the dental fastener of FIG. 2A.

FIG. 9H shows a side cross-sectional exploded view of another embodiment of the digital model of FIG. 9A coupled with the prosthesis of FIG. 1A and the dental fastener of FIG. 2A.

FIG. 10A shows a front, top, perspective view of a dental fastener.

FIG. 10B shows a front view of the dental fastener of FIG. 10A.

FIG. 10C shows a top view of the dental fastener of FIG. 10A.

FIG. 11A shows a front, top, perspective view of a dental fastener.

FIG. 11B shows a front view of the dental fastener of FIG. 11A.

FIG. 11C shows a front, bottom, perspective view of the dental fastener of FIG. 11A.

FIG. 12A shows a front, top, perspective view of a dental fastener.

FIG. 12B shows a front view of the dental fastener of FIG. 12A.

FIG. 12C shows a front, bottom, perspective view of the dental fastener of FIG. 12A.

FIG. 13A shows a side view of six different dental fastener.

FIG. 13B shows a top view of the dental fasteners of FIG. 13A.

FIG. 13C shows a side, top, perspective view of the dental fasteners of FIG. 13A.

### DETAILED DESCRIPTION OF THE INVENTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

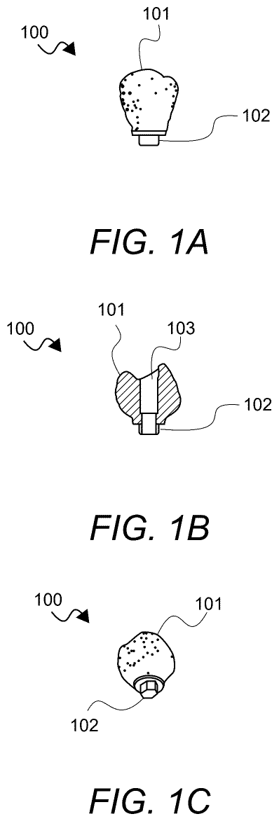

FIG. 1A shows a prosthesis 100. Prosthesis 100 is designed to replace a missing tooth in a dental arch. Prosthesis 100 permanently attaches to a fixture or implant that has been placed in the bone of a dental arch. Prosthesis 100 has a crown 101 that functions as a tooth. Crown 101 is sized and dimensioned to fit inside the dental arch within an implant site and next to other teeth or prostheses. Prosthesis 100 also has one or more interfacing surfaces 102 that mate with one or more interfacing surfaces of the fixture or implant. FIG. 1B shows a cross-sectional view of prosthesis 100. Prosthesis 100 also has a thru-hole 103 for attaching prosthesis 100 to a fixture or implant using a dental fastener, such as a screw. FIG. 1C shows a bottom perspective view of prosthesis 100. Interfacing surface 102 has a hexagonal shape that is configured to mate with a hexagonal opening or hole in the fixture or implant placed in the dental arch.

Crown 101 and interfacing surface 102 can be one unitary component or two separate parts that have been attached together. In some embodiments, crown 101 is typically made of a ceramic and interfacing surface 102 is made of metal.

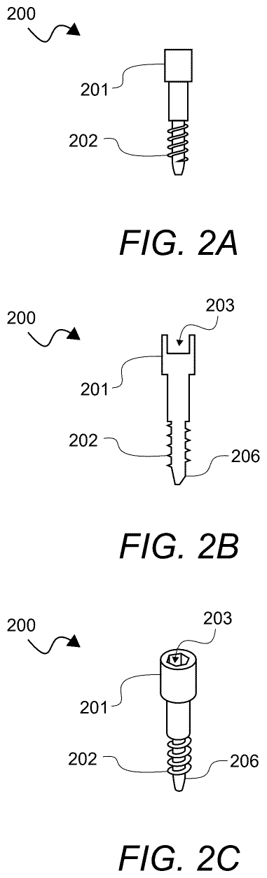

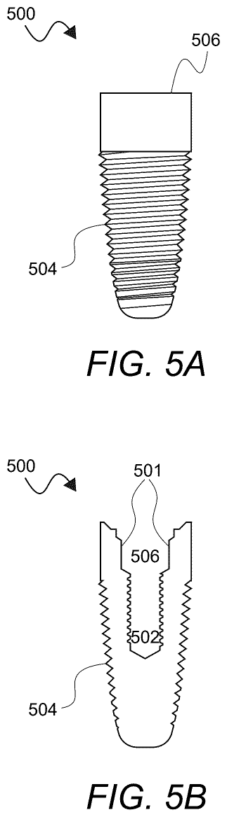

FIG. 2A shows a dental fastener 200 for fastening prosthesis 100 to a model of a dental arch. Fastener 200 is made of a hard and malleable material such as a metal or metal alloy. Fastener 200 has a head 201 and an external thread 202. Head 201 is sized and dimensioned to fit inside thru-hole 103 of prosthesis 100, but not past the shoulder inside thru-hole 103. External thread 202 is sized and dimensioned to mate with internal threads in a resin model. External thread 202 has a different size, dimension, and thread ratios than the internal thread of the fixture or implant that is permanently placed in the patient's dental arch (e.g., external thread 502 in FIG. 5B) because the permanent fixture or implant is typically made of metal, and is designed for metal-to-metal contact rather than metal-to-resin contact. For example, the threads of metal screws and metal fixtures or implants have an external thread with a thread-pitch-to-thread-diameter ratio less than 0.26 and a thread depth (thread-minor-diameter-to-thread-major-diameter) ratio greater than 0.68. In contrast, external thread 202 of dental fastener 200 has a thread-pitch-to-thread-diameter ratio of at least 0.26 and a thread depth (thread-minor-diameter-to-thread-major-diameter) ratio of no more than 0.68. In some embodiments, external thread 202 can be sandblasted and/or coated with a material to increase friction with a dental model made of resin.

FIG. 2B shows a cross-sectional view of fastener 200. FIG. 2C shows a top perspective view of fastener 200. Head 201 has an opening 203 for mating with a tool for rotating fastener 200. Fastener 200 also has a tapered end 206 with a sharp edge to help with cleaning and cutting threads into a resin or soft material.

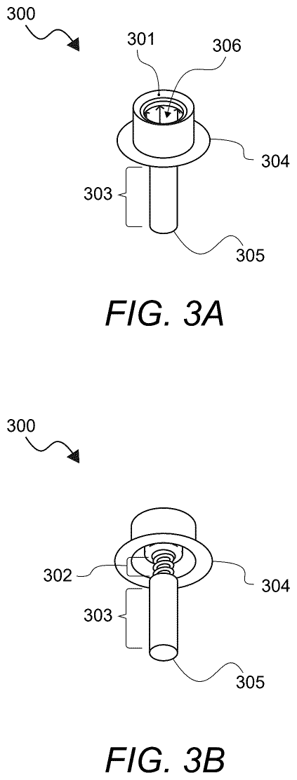

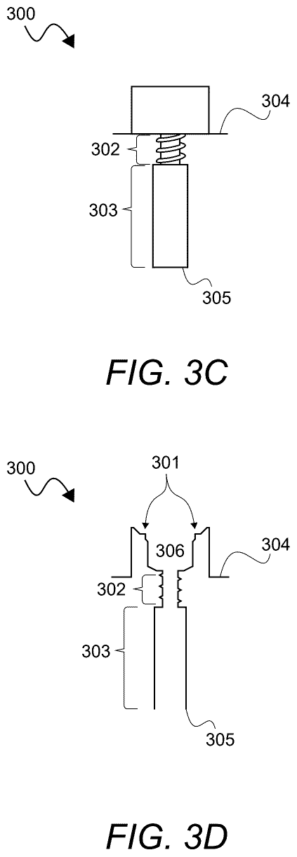

FIG. 3A shows a front, top, perspective view of a three-dimensional digital image of an object 300 in a library file. The library file is sold with fastener 200 and can be used to create a dental model that has an interfacing surface 301 that mates with the interfacing surface 102 of prosthesis 100. Object 300 can also be used to create a dental model that has an internal thread 302 configured to couple with the external thread 202 of dental fastener 200. Object 300 comprises of a plurality of boundary lines that can be used to define features and negative spaces in a dental model. The library file provides usable (e.g., unencrypted) information about the boundary lines so that they can be melded with a scanned image of the dental arch using digital modeling software. The digital model can then be used to manufacture a physical model.

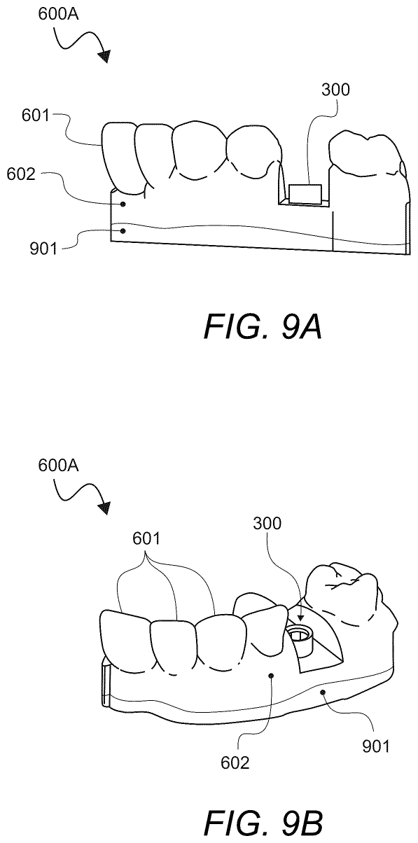

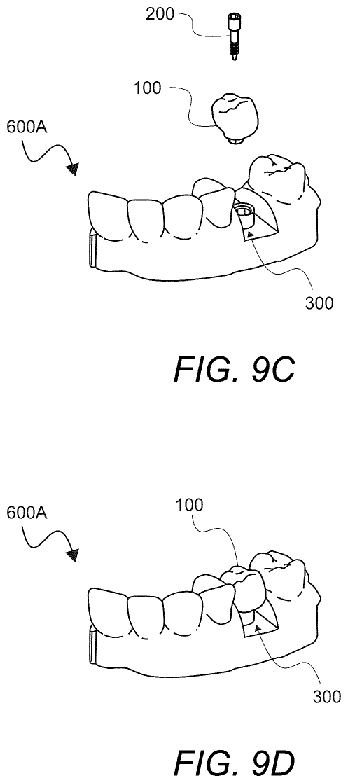

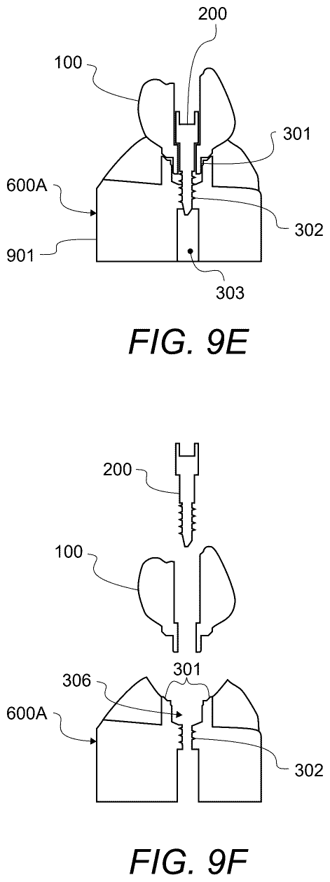

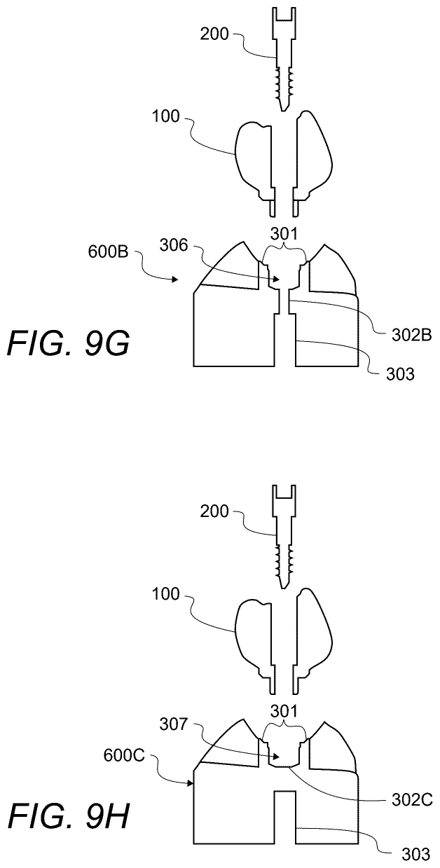

FIG. 3B shows a front, bottom, perspective view of object 300. FIG. 3C shows a front view of object 300. FIG. 3D shows a cross-sectional view of object 300. Object 300 has a head portion with a thru-hole 306, one or more interfacing surfaces 301, and an annular flange 304. The height of the head portion (e.g., from annular flange 304 to the top of the rim) is adjustable and the dimension is determined based on the dimensions of the dental arch and implant. Thru-hole 306 has a hexagonal shape that mates with the hexagonal shape of interfacing surface 102 of prosthesis 100. Those of skill in the art will appreciate that many other shapes besides hexagons can be used in a manner that is consistent with the inventive concepts disclosed herein. Interfacing surface 301 is the surface area in thru-hole 306 that couples with interfacing surface 101 of prosthesis 100. It should be noted that “interfacing surface” merely mean coupling surfaces, and does not necessarily mean contacting surfaces. For example, interfacing surface 301 and interfacing surface 101 do not physically contact one another across their entire surface area, and may have spaces therebetween, as shown in FIG. 9E. However, their surfaces are sized and dimensioned to securely affix, and mechanically engage, with one another so that prosthesis 100 can be fastened to a dental model using fastener 200. It should also be appreciated that the interfacing surfaces can include both inner and outer surfaces of the head of object 300. In multi-unit abutments for example, the interfacing surfaces can include surfaces that are outside of hole 306 on object 300.

Object 300 also has an internal thread 302, a vent 303, and a bottom end 305. Internal thread 302 is sized and dimensioned to mate with external thread 202 of fastener 200. Internal thread 302 is preferably sized and dimensioned so that the dental model can be made of a soft material such as resin and can engage with an external thread made of a hard material such as metal. The length of bottom end 305 is adjustable so that vent 303 can be designed to create a thru-hole in the dental model, which allows residual resin material to be removed from the model when fastener 200 is screwed into internal threads 302.

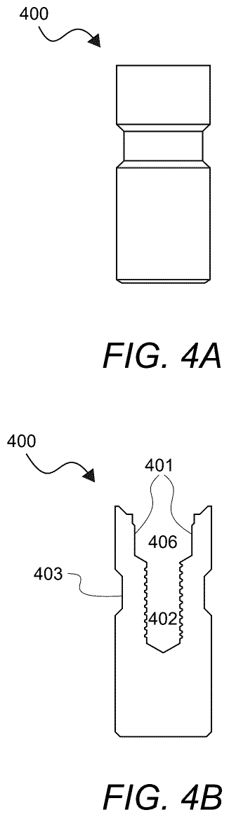

FIG. 4A shows a front view of an analog 400. FIG. 4B shows a cross-sectional view of analog 400. Analog 400 has an exterior groove 403 that is used to cement analog 400 into a hole in a dental model. Analog 400 is typically made of a hard material, such as metal. Analog 400 has a blind-hole 406 with an interfacing surface 401 that is sized and dimensioned to mate with interfacing surface 102 of prosthesis 100. Analog 400 also has an internal thread 402 that is sized and dimensioned to identically match the internal thread of a permanent fixture or implant in a patient's dental arch.

FIG. 5A shows a front view of a fixture or implant 500 for attaching a prosthesis to a dental arch. FIG. 5B shows a cross-sectional view of implant 500. Implant 500 is typically made of a hard material, such as metal. Implant 500 has an external thread 504 that screws into a patient's bone. Implant 500 also has a blind hole 506 and an interfacing surface 501 that are sized and dimensioned to receive interfacing surface 102 of prosthesis 100. Implant 500 also has an internal thread 502 sized and dimensioned to mate with a dental fastener. Thread 502 is sized and dimensioned for a metal-to-metal connection with a dental fastener so that prosthesis 100 can be worn permanently (e.g., for long term use) in the patient's mouth and can be used to chew food.

Object 300 eliminates the need for analog 400 by creating a digital model of a dental arch that has the interfacing surfaces of fixture or implant 500 integrated therein. Object 300 can also be optionally used to create a dental model that has an internal thread integrated therein. The internal thread could have the same size and dimension as thread 502 of implant 500. Alternatively, object 300 can be used to create a dental model with a different internal thread than implant 500. More specifically, object 300 can be used to adjust the thread size in the dental model so that the thread works for resin-to-metal contact. In this manner, object 300 advantageously creates a dental model with all the mating features of an analog, fixture, or implant, integrated therein, and allows for a metal or ceramic prosthesis to be attached to a resin dental model using a metal or ceramic screw. Those of skill in the art will appreciate that object 300 can have different boundary configurations that are configured to operate within different types of three-dimensional environments (e.g., different computer-aided design software), formats, and file extensions.

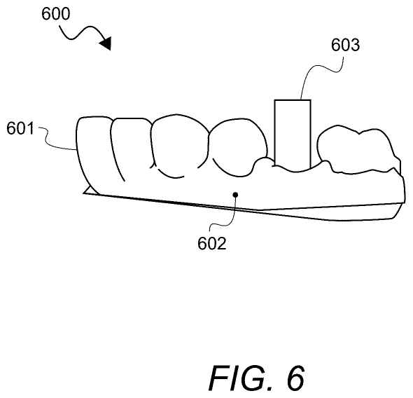

FIG. 6 shows a scanned image of a dental arch 600. Dental arch 600 could have one or more real or prosthetic teeth 601 and soft tissue 602. Dental arch 600 also has a scan body 603 attached to a fixture or implant 500 under soft tissue 602. As used herein, scan body means any feature or object that is scannable and can be used to locate a fixture or implant. The scanned image of dental arch 600 is uploaded into a digital environment, such as three-dimensional drawing or modeling software. A library file that contains object 300 positionally related to a three-dimensional image of scan body 603 can also be uploaded into the modeling software.

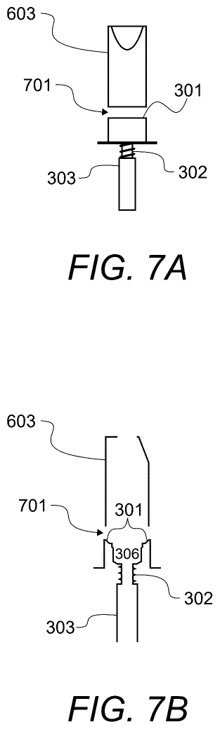

FIG. 7A shows a front view of a three-dimensional image of scan body 603 positioned relative to object 300 by a space 701. FIG. 7B shows a cross-sectional view of scan body 603 and object 300. The defined positional relationship between object 300 and scan body 603 in the library file can be used to locate and position object 300 withing the scanned image of dental arch 600.

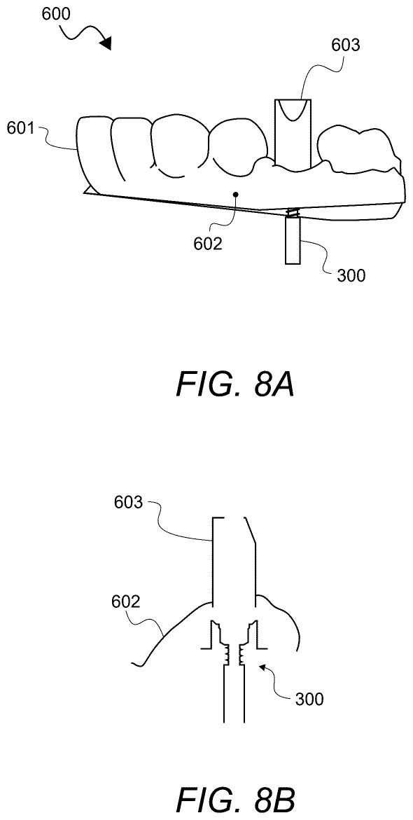

FIG. 8A shows the scanned image of dental arch 600 positioned with object 300 in the digital environment. FIG. 8B shows a cross-sectional view of object 300 properly positioned and aligned with scan body 603 in the scanned image of dental arch 600. Once object 300 is positioned within the scanned image, scan body 603 is then removed from the image, and the boundary lines that define interfacing surface 301, thru-hole 306, internal thread 302, and vent 303 are melded to the scanned image of the dental arch 600 to create a digital model. An extra bottom layer of material can optionally be added to the bottom of the model to facilitate manufacturing and handling of a physical model.

FIG. 9A shows a side view of a digital model 600A of dental arch 600. FIG. 9B shows a side, top, perspective view of digital model 600A. Digital model 600A comprises the scanned image of dental arch 600 melded with object 300 and an added bottom layer 901.

The library file can include a three-dimensional image of prosthesis 100 and dental fastener 200. Prosthesis 100 and fastener 200 can be fitted with model 600A in the digital environment before attaching prosthesis 100 to the patient's mouth. FIG. 9C shows a side, top, perspective view of digital model 600A in an exploded view with prosthesis 100 and dental fastener 200. FIG. 9D shows a side, top, perspective view of digital model 600A coupled with prosthesis 100 and dental fastener 200. FIG. 9E shows a side cross-sectional view of digital model 600A with an optional soft tissue analog, coupled with prosthesis 100 and dental fastener 200. FIG. 9F shows a side cross-sectional exploded view of digital model 600A with an optional soft tissue analog, prosthesis 100, and dental fastener 200. The head of dental fastener 200 is sized and dimensioned to fit inside a first internal diameter of through-hole 103 of the prosthesis 100 and is further sized and dimensioned to not pass through a second internal diameter of though-hole 103 of the prosthesis 100. The first and second internal diameters meet at a step or shoulder, which prevents the head of fastener 200 from passing therethrough.

FIG. 9G shows a side cross-sectional exploded view of a digital model 600B, which is identical to digital model 600A, except that internal thread 302 is replaced by a thread-less hole 302B. The internal diameter of hole 302B is smaller than external thread 202 such that fastener 202 will cut threads into hole 302B when rotatably coupled together. FIG. 9H shows a side cross-sectional exploded view of a digital model 600C, which is identical to digital model 600A, except that internal thread 302 is replaced with a bottom surface 302C of a blind hole. In this manner, external thread 202 of fastener 200 will cut into bottom surface 302C when rotatably coupled together. Those of ordinary skill in the art will appreciate that digital model 600B and digital model 600C can be used rather than digital model 600A when dental fastener 200 is a self-tapping or self-threading screw. FIGS. 9E-9H show an optional soft tissue analog coupled with the digital model 600A, 600B, 600C (not labeled).

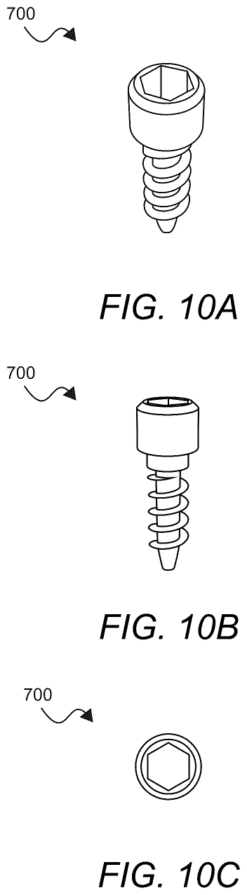

FIG. 10A shows a front, top, perspective view of another embodiment of a dental fastener 700. FIG. 10B shows a front view of dental fastener 700. FIG. 10C shows a top view of dental fastener 700. Dental fastener 700 is designed to fasten a crown into the connection geometry of a multiunit abutment that has been integrated into a 3D printed model. The screw head has a flat bottomed, butt joint connection and an internal hex socket.

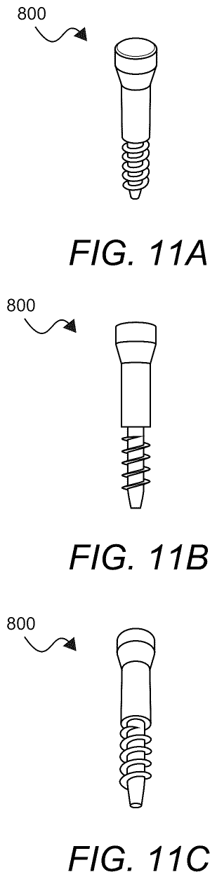

FIG. 11A shows a front, top, perspective view of another embodiment of a dental fastener 800. FIG. 11B shows a front view of dental fastener 800. FIG. 11C shows a front, bottom, perspective view of dental fastener 800. Dental fastener 800 is designed to fasten an abutment or crown directly into the connection geometry of a dental implant that has been integrated into a 3D printed model. The screw head has a conical connection, which may create a tighter seal between the abutment and the screw when they are torqued together.

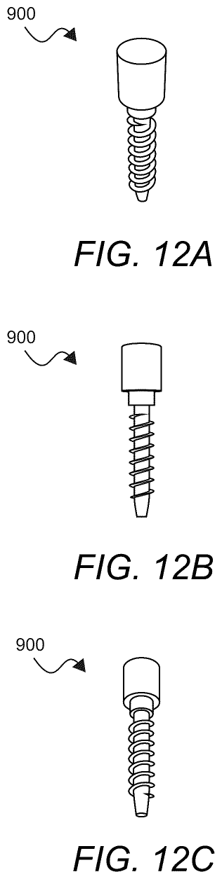

FIG. 12A shows a front, top, perspective view of another embodiment of a dental fastener 900. FIG. 12B shows a front view of dental fastener 900. FIG. 12C shows a front, bottom, perspective view of dental fastener 900. Dental fastener 900 is designed to fasten an abutment or a crown directly into the connection geometry of a dental implant that has been integrated into a 3D printed model. The screw head has a flat bottomed, butt joint connection.

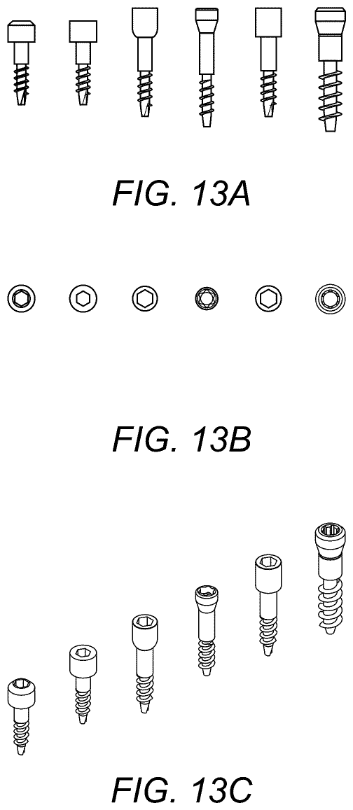

FIG. 13A shows a side view of six different dental fasteners. FIG. 13B shows a top view of the six dental fasteners of FIG. 13A. FIG. 13C shows a side, top, perspective view of the six dental fasteners of FIG. 13A. Those of ordinary skill in the art will appreciate that numerous configurations of fasteners can be used consistently with the inventive concepts disclosed herein.

From a methods perspective, the inventive subject matter includes a method of using a dental fastener by: placing the head of the fastener through the first internal diameter of the through-hole of the prosthesis; and fastening the external thread of the dental fastener to the internal thread of the model.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C. and N, the text should be interpreted as requiring only one element from the group, not A plus N, or B plus N, etc.

What is claimed is:

1. A dental fastener for fastening a prosthesis to a physical model, the dental fastener comprising:
a screw having an external thread and a head;
a library file comprising (i) a three-dimensional digital image of one or more interfacing surfaces of the prosthesis, (ii) a three-dimensional digital image of one or more interfacing surfaces of a fixture or implant, and (iii) a three-dimensional digital image of an internal thread configured to couple with the external thread of the screw;
wherein the external thread of the screw is configured to fasten with the internal thread of the physical model; and
wherein the head of the screw is sized and dimensioned to couple with the prosthesis.

2. The dental fastener of claim 1, wherein the one or more interfacing surfaces of the prosthesis is a bottom surface of an abutment.

3. The dental fastener of claim 1, wherein the physical model has one or more interfacing surfaces defined by the three-dimensional digital image of the one or more interfacing surfaces of the fixture or implant.

4. The dental fastener of claim 3, wherein the one or more interfacing surfaces of the physical model and the internal thread of the physical model are integrally formed by a 3D printing process.

5. The dental fastener of claim 1, wherein the head of the screw has a negative space sized and dimensioned to mate with a tool.

6. The dental fastener of claim 1, wherein the screw is made of metal or ceramic and the physical model is made of resin.

7. The dental fastener of claim 6, wherein the head of the screw is sized and dimensioned to fit inside a first internal diameter of a through-hole of the prosthesis and is further sized and dimensioned to not pass through a second internal diameter of the though-hole of the prosthesis.

8. A method of using the dental fastener of claim 7, comprising:
placing the screw through the first internal diameter of the through-hole of the prosthesis; and
fastening the external thread of the metal or ceramic screw to the internal thread of the resin physical model.

9. The dental fastener of claim 1, wherein the external thread of the screw has a thread-pitch-to-thread-diameter ratio of at least 0.26.

10. The dental fastener of claim 1, wherein the external thread of the screw has a thread depth (thread-minor-diameter-to-thread-major-diameter) ratio of no more than 0.68.

11. The dental fastener of claim 1, wherein the fixture or implant has an internal thread with a different thread-pitch-to-thread-diameter ratio and a different thread depth than the external thread of the screw.

12. The dental fastener of claim 1, wherein the library file further comprises (iv) a three-dimensional digital image of a scan body aligned with the three-dimensional digital image of the interfacing surfaces of the fixture or implant and the three-dimensional digital image of the internal thread.

13. A dental fastener for fastening a prosthesis to a model, wherein the dental fastener has an external thread comprising:
a thread-pitch-to-thread-diameter ratio of at least 0.25; and
a thread depth ratio of no more than 0.7.

14. A library file for generating a digital model of a dental arch comprising:
a three-dimensional image of one or more interfacing surfaces of a fixture or implant; and
a three-dimensional image of an internal thread having (i) a thread-pitch-to-thread-diameter ratio of at least 0.25, and (ii) a thread depth ratio of no more than 0.7.

15. A method of designing a three-dimensional digital model of a dental arch having (i) one or more interfacing surfaces for coupling with one or more interfacing surfaces of a prosthesis and (ii) an internal thread configured to couple with an external thread of a dental fastener, comprising;
positioning, in a digital environmental, (i) a three-dimensional image of one or more interfacing surfaces of the fixture or implant and (ii) a three-dimensional image of an internal thread, with (iii) a scanned image of the dental arch;
removing, in the digital environment, a scan body from the scanned image of the dental arch; and
melding, in the digital environment, (i) the three-dimensional image of the one or more interfacing surfaces of the fixture or implant and (ii) the three-dimensional image of the internal thread, into (iii) the scanned image of the dental arch to create the three-dimensional digital model of the dental arch.

15. The method of claim 14, wherein the fixture or implant has an internal thread with a different thread-pitch-to-thread-diameter ratio and/or a different thread depth ratio than the internal thread of the digital model.

16. The method of claim 15, wherein the thread-pitch-to-thread-diameter ratio and the depth ratio of the internal thread is the same as the thread-pitch-to-thread-diameter ratio and the depth ratio of the external thread of the dental fastener.

17. A dental fastener for fastening a prosthesis to a physical dental model, the dental fastener comprising:
a self-tapping screw having an external thread and a head;
a library file comprising (i) a three-dimensional digital image of one or more interfacing surfaces of the prosthesis, and (ii) a three-dimensional digital image of one or more interfacing surfaces of a fixture or implant; and
wherein the head of the screw is sized and dimensioned to couple with the prosthesis.

18. The dental fastener of claim 17, wherein the library file further comprises (iii) a three-dimensional digital image of a through-hole having an inner diameter that is smaller than an outer diameter of the external thread of the self-tapping screw.

19. The dental fastener of claim 17, wherein the three-dimensional digital image of the one or more interfacing surfaces of the fixture or implant includes a blind hole.

20. The dental fastener of claim 17, wherein the external thread is sandblasted or coated with a material to increase friction with a physical dental model made of resin.
